(19) United States
(12) Patent Application Publication
(10) Pub. No.: US 2002/0171789 A1
(43) Pub. Date: Nov. 21, 2002

(54) Layered type reflective full-color liquid crystal display element and display device having the element

(75) Inventors: Hideaki Ueda, Kishiwada-Shi (JP); Kiyofumi Hashimoto, Suita-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/191,996

(22) Filed: Jul. 9, 2002

Related U.S. Application Data
(63) Continuation-in-part of application No. 08/759,347, filed on Dec. 3, 1996.

(30) Foreign Application Priority Data
Dec. 4, 1995 (JP) 07-315147
Sep. 12, 1996 (JP) 08-241951
Jul. 13, 2001 (JP) 2001-214467

(51) Int. Cl. G02F 1/1335

(52) U.S. Cl. 349/106

(57) ABSTRACT

Disclosed is a reflective color liquid crystal display element having a four layered structure. The display element specifically comprises the following layers from an observation side: a single layer of a liquid crystal cell which comprises a chiral nematic liquid crystal composition for the blue color reflection; a single layer of a liquid crystal cell which comprises a chiral nematic liquid crystal composition for the green color reflection; and two layers of liquid crystal cells each of which comprises a chiral nematic liquid crystal composition for the red color reflection. In some of the embodiments, a phase difference plate is inserted between the two liquid crystal cells for the red color reflection.

### CROSS-REFERENCE TO RELATED APPLICATION

This application is a continuation-in-part of Ser. No. 08/759,347, filed on Dec. 3, 1996 that is based on Japanese Patent Applications Nos. HEI 7-315147 and HEI 8-241951 filed on Dec. 4, 1995 and on Sep. 12, 1996, respectively. Also this application is based on Japanese Patent Application No. 2001-214467 filed on Jul. 13, 2001. The entire content of them is hereby incorporated by reference.

### BACKGROUND OF THE INVENTION

1. Field of the Invention

The present invention relates to a reflective full-color liquid crystal display element, particularly a reflective full-color liquid crystal display element in which liquid crystal cells for selectively reflecting lights of R (red), G (green) and B (blue) which are three primary colors of a light are laminated (layered) and a display device having the element.

2. Description of the Related Art

In general, a liquid crystal display element is composed of a pair of substrates having transparent electrodes and a liquid crystal layer which is held between the substrates. A drive voltage is applied to the liquid crystal layer so that an alignment of liquid crystal molecules is controlled, and a light which enters the element from outside thereof is modulated and thus an objective image is displayed.

Various methods have been conventionally suggested as liquid crystal display systems. In recent years, liquid crystal display elements that which use a chiral nematic liquid crystal composition which shows a cholesteric liquid crystal phase appears at room temperate by adding a chiral material to nematic crystal, have been studied.

It is known that such a liquid crystal display element is used as a reflective liquid crystal display element characterized by a low power consumption which utilizes selective reflection of a cholesteric phase, for example. In the reflective liquid crystal display element, for example, a pulse voltage with high or low energy is applied selectively, and the liquid crystal is switched between a planer state (colored state) and a focal conic state (transparent state) so that display is carried out. Also, after the application of the pulse voltage is stopped, the planer state, the focal conic state or their mixed state is held so that display can be maintained after the application of the voltage is stopped. The holding state or stable state of the planer and focal conic states is generally called as bistability or memory property.

In addition, as one method of realizing full-color display of the liquid crystal display element, a liquid crystal display element where three layers composed of a liquid crystal cell for red display, a liquid crystal cell for green display and a liquid crystal cell for blue display are laminated is considered.

However, in the reflective full-color liquid crystal element using this chiral nematic liquid crystal composition, since a reflectance of the liquid crystal cell for red display is low, there arises a problem that a color reproduction range is narrow and a white balance is not good and also the contrast is low. In the chiral nematic liquid crystal composition which selectively reflects red, since a content of the chiral material is small and a twisting pitch is long, in the case where the thickness of the liquid crystal layer is the same as that of liquid crystal compositions which selectively reflect green and blue, the reflectance essentially becomes low.

As one method of compensating this disadvantage, a method of thickening a liquid crystal layer for red display to improve the reflectance can be suggested. However, as the liquid crystal layer becomes thicker, the transparency in the focal conic state becomes lower and black display property is lowered. For this reason, the liquid crystal layer for red display cannot be thickened much. Moreover, when the liquid crystal layer becomes thick, a drive voltage becomes high, and thus there arises a problem that a low-cost and general-purpose driving IC cannot be used.

### SUMMARY OF THE INVENTION

Therefore, it is an object of the present invention to provide a reflective full-color liquid crystal display element in which a color reproduction range is wide, a white balance is good and a contrast is high by using a chiral nematic liquid crystal composition.

It is another object of the present invention is to provide a reflective full-color liquid crystal display element in which a reflectance is heightened without greatly lowering a black display property by using a chiral nematic liquid crystal composition.

It is still another object of the present invention is to provide a reflective full-color liquid crystal display element which can be manufactured at low price and in which a drive voltage is low by using a chiral nematic liquid crystal composition.

It is still another object of the present invention is to provide a display device which provides good display property and a simple structure and can reduce the cost.

In order to solve the above problems, the inventors of the present invention made studies enthusiastically. What is found is that one layer of a liquid crystal cell which selectively reflects blue, one layer of a liquid crystal cell which selectively reflects green, and two layers of liquid crystal cells which are the farthest from an observing side and selectively reflect red were laminated, so that a reflectance of red was improved and thus the conventional problems can be solved.

Namely, the reflective full-color liquid crystal display element of the present invention is constituted so that a plurality of liquid crystal cells, which hold liquid crystal layers composed of chiral nematic liquid crystal compositions, which are made of a nematic liquid crystal mixture and a chiral material and show a cholesteric phase at room temperature and selectively reflect a light of a specified wavelength in a visible ray, are laminated in thickness direction between a pair of substrates, at least one of which is transparent. In such a liquid crystal display element, a liquid crystal cell which selectively reflects blue, a liquid crystal cell which selectively reflects green and a liquid crystal cell which selectively reflects red are laminated, one layer of the liquid crystal cell which selectively reflects blue and one layer of the liquid crystal cell which selectively reflects green are provided, and two layers of the liquid crystal cells which selectively reflect red are provided.

In the reflective full-color liquid crystal display element of the present invention, when two layers of the liquid crystal cells which selectively reflect red are provided, a reflectance of red becomes high, a color reproduction range becomes wide, and a white balance and contrast are improved. Moreover, the element can be manufactured at low price by using general-purpose driving ICs without heightening a drive voltage. Further, it is not necessary to thicken a liquid crystal layer which selectively reflects red, and there is no fear that black display is deteriorated.

In the reflective full-color display element of the present invention, it is preferable that the respective liquid crystal layers, which compose the liquid crystal cell which selectively reflects blue, the liquid crystal cell which selectively reflects green, the first liquid crystal cell and the second liquid crystal cell which selectively reflect red, have approximately equivalent thickness. As a result, the manufacturing step can be used in common to the utmost, and thus the element can be manufactured at low price. Moreover, all the liquid crystal cells can be driven by the equivalent voltages.

Particularly when the liquid crystal cell which selectively reflects blue, the liquid crystal cell which selectively reflects green, the first liquid crystal cell and the second liquid crystal cell which selectively reflect red are driven by substantially equivalent voltages, a common driving IC can be used for all the liquid crystal cells, and the cost can be further reduced.

In addition, as for the liquid crystal cell which selectively reflects blue, the liquid crystal cell which selectively reflects green, the first liquid crystal cell and the second liquid crystal cell which selectively reflect red, their respective peak reflection wavelengths of reflection spectrum are adjusted to 450 to 490 nm, 550 to 590 nm, 650 to 690 nm and 650 to 690 nm, respectively, so that color reproductivity becomes wider, and more satisfactory white display is possible, and contrast is further improved.

In order to obtain preferable display, it is suitable that the thickness of the liquid crystal layers is 3 to 10 μm. When the thickness is thinner than 3 μm, the reflectance becomes low, and thus a satisfactory coloring state cannot be obtained. On the contrary, when the thickness is thicker than 10 μm, the drive voltage becomes high, black display is deteriorated and the contrast becomes low.

A phase difference plate may be held between the first liquid crystal cell and the second liquid crystal cell which selectively reflect red. As a result, the reflectance of red is improved greatly. In this case, when the chiral nematic liquid crystal compositions which compose the first and second liquid crystal cells for selectively reflecting red have the same component, the manufacturing step is used in common, and thus the manufacturing cost becomes low.

Chiral materials included in the chiral nematic liquid crystal compositions composing the first and second liquid crystal cells for selectively reflecting red may have opposite optical rotating directions. Since reflected lights of both right optical rotation and left optical rotation can be used for display, the reflectance is improved greatly.

The chiral nematic liquid crystal composition has an advantage that a selective reflecting wavelength can be controlled by changing the content of the chiral material. The content of the chiral material is satisfactorily 8 to 45% by weight with respect to a total weight of the nematic liquid crystal mixture and the chiral material, and when the content of the chiral material is too smaller than 8% by weight, sufficient memory property cannot be occasionally obtained. On the contrary, when the content is too larger than 45% by weight, a cholesteric phase does not occasionally appear at room temperature or the composition is occasionally solidified.

Further, two or more kinds of chiral materials are mixed, so that a shift amount of the selective reflection wavelength due to temperature can be adjusted, and stable temperature property can be shown. Moreover, a dyestuff is added to the liquid crystal composition, so that color purity of a reflection peak wavelength can be improved. Conventionally-known various dyestuffs can be used as the dyestuff to be added, and a dyestuff with satisfactory solubility with the liquid crystal composition is suitably used. For example, an azo dyestuff, a quinone compound, an anthraquinone compound, a two-tone dyestuff or the like can be used, and plural kinds of these dyestuffs may be used. It is preferable that an adding amount is not more than 3% by weight, for example, with respect to a total amount of a nematic liquid crystal compound and a chiral material. When the adding amount is too large, the selective reflection of the liquid crystal becomes low, and the contrast is lowered.

In addition, a color filter may be provided instead of or with the addition of the dyestuff to the liquid crystal composition. For example, a filter layer can be provided in a liquid crystal cell. As a material to be used as the filter layer, for example, a material obtained by adding a dyestuff to a water-white substance, or a material which is essentially in a colored state without adding a dyestuff may be used. For example, the filter layer may be a thin film which is composed of a specified substance which fulfills the same function as that of a dyestuff. Even if the transparent substrate itself for composing the liquid crystal cell is replaced by such a filter layer material, the same effect is produced.

It is preferable that as for a pair of substrates for holding a liquid crystal composition, at least one of them is a resin substrate. When the resin substrate is used, it has an advantage that thinning and light weighting can be realized and even if it is dropped, it is not broken. Moreover, since the thickness of the substrate can be thinned, color drift in the case where the four-layered liquid crystal cells are laminated can be eliminated or reduced.

Further, at least one of the substrates composing each liquid crystal cell is the resin substrate which is provided with electrodes on its both faces and is used in common for adjacent liquid crystal cells, so that a number of substrates can be reduced, and this contributes to decrease in the cost.

A space material made of inorganic corpuscles coated with adhesive resin may be provided between a pair of substrates. A gap between the substrates can be kept stable, and there does not arise a problem such that the space material flows due to adhesiveness and irregularity of display occurs.

Further, a plurality of macromolecular structures are provided between a pair of substrates, so that a liquid crystal display element with a large area can be manufactured, and accuracy and strength of the gap between the substrates can be heightened. Moreover, a memory property as an element is improved.

### BRIEF DESCRIPTION OF THE DRAWINGS

These and other objects, advantages and features of the invention will become apparent from the following description thereof taken in conjunction with the accompanying drawings in which:

FIGS. 1 through 8 are cross-sectional views showing liquid crystal display elements according to first through eighth embodiments of the present invention; and

FIGS. 9(A), 9(B) and 9(C) are schematic perspective views showing display devices according to the present invention.

### DETAILED DESCRIPTION OF THE PREFERRED EMBODIMENTS

There will be explained below preferred embodiments of a reflective full-color liquid crystal display element according to the present invention with reference to the drawings.

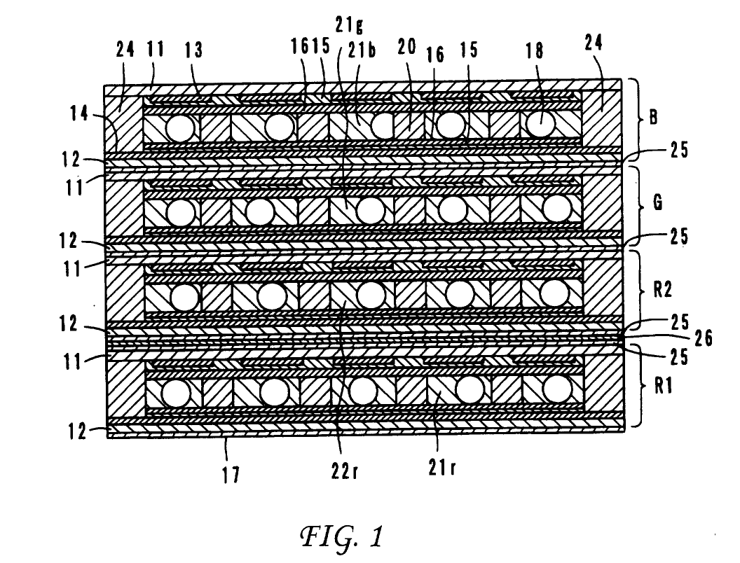

(First Embodiment, see FIG. 1)

FIG. 1 shows a sectional structure of a reflective full-color liquid crystal display element according to the first embodiment reflecting aspects of the present invention. This liquid crystal display element is constituted so that two liquid crystal cells R1 and R2 which selectively reflect red, a single liquid crystal cell G which selectively reflects green, a single liquid crystal cell B which selectively reflects blue are laminated in this order from bottom to top. The liquid crystal cells R1, R2, G and B include liquid crystal compositions 21r, 22r, 21g and 21b, respectively. The respective liquid crystal cells are bonded to one another by a transparent adhesive 25. Moreover, a phase difference plate 2G is inserted between the liquid crystal cells R1 and R2.

In the liquid crystal cells R1, R2, G and B, 11 and 12 are transparent substrates having light transmissivity, and a plurality of transparent electrodes 13 and 14, which are formed into a strip form so as to be parallel with one another, are provided on surfaces of the transparent substrates 11 and 12, respectively. The electrodes 13 and 14 face one another so as to cross one another viewed from a direction vertical to the substrates 11 and 12. It is preferable that the electrodes 13 and 14 are coated with insulating thin films. In the first embodiment, the electrodes 13 and 14 are coated with insulating thin films 15. Further, alignment stabilizing films 16 for stabilizing alignment of the liquid crystal are provided on the insulating thin films 15, respectively.

Visible ray absorbing layer may be provided on outer face (rear faces) of the substrate 12 that is located opposite to a light entering side, as the need arises. In this embodiment, a visible ray absorbing layer 17 is provided on the rear face of the substrate 12 in the liquid crystal cell R1.

20 is a column-shaped structure as a space holding member. 21r, 22r, 21g and 21b are chiral nematic liquid crystal compositions showing a cholesteric phase at room temperature. Their materials and their combinations will be explained concretely in the following examples. Reference numeral 24 is a sealing material which seals the liquid crystal compositions 21r, 22r, 21g and 21b between the substrates 11 and 12.

(Substrates)

While all the substrates 11 and 12 have light transmissivity, at least the substrate 12 of the liquid crystal cell R1 may not has light transmissivity. For example the substrate of the liquid crystal cells R1 may be black so that visible rays are absorbed thereby. In this case, no separate visible ray absorbing layer 17 is required. On the other hand, as to the remaining ones of the substrates 11 and 12, they should have light transmissivity. An example of the substrate having light transmissivity is a glass substrate. Besides the glass substrate, a flexible resin substrate composed of, for example, polycarbonate, polyethersulphone, polyarylate, polyethylene terephthalate or the like can be used.

(Electrodes)

As the electrodes 13 and 14, for example, a transparent electrically conductive film made of ITO (Indium Tin Oxide), IZO (Indium Zinc Oxide) or the like, a metallic electrode made of aluminum, silicon or the like, or a photoconductive film made of amorphous silicon, BSO (Bismuth Silicon Oxide) or the like can be used.

In the liquid crystal display element shown in FIG. 1, as mentioned above, a plurality of strip-shaped transparent electrodes 13 and 14 which are parallel with each other are formed on the surfaces of the transparent substrates 11 and 12, respectively, the electrodes 13 and 14 face each other so as to cross each other viewed from the direction vertical to the substrates 11 and 12. In order to form the electrodes 13 and 14 as described above, for example, an ITO film is mask-deposited on the transparent substrate by the sputtering method or the like, or after the ITO film is formed on the whole surface, it may be patterned by the photolithography method.

(Insulating Thin Film)

An insulating thin film having a function for preventing short-circuit between the electrodes 13 and 14 and/or for improving reliability of the liquid crystal display element a gas barrier layer may be formed in the liquid crystal display element. In the first embodiment, as mentioned above, the electrodes 13 and 14 are coated with the insulating thin films 15.

Examples of the insulating thin film 15 can be inorganic materials made of silicon oxide, titanium oxide, zirconium oxide or their alkoxides, and organic films made of polyimide resin, acrylic resin or urethane resin. The insulating thin film 15 can be formed by using these materials according to well-known methods such as the deposition method, the spin-coating method and the roll-coating method.

When a dyestuff is added to the above-mentioned materials, the insulating thin film serves also as a color filter. Further, the insulating thin film can be formed also by using the same material as macromolecular resin to be used for the column-shaped structure.

(Alignment Stabilizing Film)

Examples of the alignment stabilizing film 16 are organic films made of polyimide resin, polyamide-imide resin, polyether-imide resin, polyvinyl butyral resin, acrylic resin or the like, and inorganic materials such as silicon oxide and aluminum oxide. The alignment stabilizing film 16 which is formed by using at least one of these materials is not necessarily subjected to an alignment treatment such as rubbing. Moreover, the alignment stabilizing film 16 may be used in common with the insulating thin film 15.

In the case where the alignment stabilizing film 16 is subjected to the rubbing treatment, only one film is lightly subjected to the rubbing treatment (for example, with the rubbing density of not more than 20) so that the reflectance can be improved. However, when both the alignment stabilizing films 16 are subjected to the rubbing treatment, the memory property easily disappears.

(Spacers)

In the liquid crystal display element of the first embodiment, spacers 18 are inserted and dispersed between the substrates 11 and 12 so as to holding a gap between the substrates uniformly. However, the spacers 18 may be omitted in a certain application areas.

An example of the spacer 18 can be a sphere made of resin or inorganic oxide. Moreover, a fixing spacer of which surface is coated with thermoplastic resin is also used suitably. Particularly, inorganic corpuscles which are covered with adhesive resin are used as the space holding member so that a cell gap can be maintained stably. Further, since the inorganic corpuscles have an adhesive property, the spacer doe not flow and there does not arise a problem that irregularity of display occurs.

The spacers 18 and the column-shaped structures 20 may be provided like the first embodiment, but instead of the column-shaped structures 20, only the spacers 18 may be used as the space holding member.

(Liquid Crystal Composition)

The liquid crystal composition includes a nematic liquid crystal mixture an a chiral material, and is a chiral nematic liquid crystal composition that contains the chiral material in a range from 8 to 45% by weight. Here, an adding amount of the chiral material is a value when a total amount of the nematic liquid crystal mixture and the chiral material is 100% by weight. When the adding amount of the chiral material is much smaller than 8% by weight, a desirable selective reflection wavelength and/or sufficient memory property occasionally cannot be obtained. When the adding amount is much lager than 45% by weight, a cholesteric phase does not occasionally appear at room temperature and/or the composition is occasionally solidified.

As for physical property values of the chiral nematic liquid crystal composition to be used here, it is preferable that refractive index anisotropy (An) is 0.13 to 0.22, dielectric constant anisotropy (Δε) is 5 to 40 and viscosity is 20 to 200 cP. When the refractive index anisotropy is too low, color purity of a reflected light is not good and the reflectance is lowered. On the contrary, when the refractive index anisotropy is too high, viewing angle dependence becomes large. When the dielectric constant anisotropy is too low, a drive voltage becomes high. On the contrary, too high, stability and reliability of an element is not good, and thus a defective image and a noise of an image easily occur. When the viscosity is too low, the memory property of the display state is deteriorated. On the contrary, too high, a drive voltage becomes high and the time for driving becomes long.

(Column-Shaped Structures)

The liquid crystal display element shown in FIG. 1 is constituted so that a pair of substrates are supported by structures therebetween in order to provide a strong self-holding property. Specifically, the liquid crystal display element of the first embodiment is provided with the column-shaped structures 20 between the substrates 11 and 12.

As for the column-shaped structures 20, their structural explanations will be firstly presented. Examples of the column-shaped structure can be column-shaped structures, which are arranged with constant intervals into a predetermined pattern like a lattice arrangement or the like, such as a cylindrical body, a square column-shaped body, an oblong column-shaped body, a trapeziform column-shaped body and a conical body. Moreover, stripe-shaped bodies may be arranged with predetermined intervals. It is preferable that the arrangement of the column-shaped structures is not a random arrangement but equal-interval arrangement, an arrangement where intervals change gradually, or an arrangement where a predetermined pattern is repeated with constant cycle as long as the arrangement can hold the gap between the substrates suitably and does not prevent image display. The column-shaped structure can obtain a property which can be practically sufficient as the liquid crystal display element while holding suitable strength if a percentage of an area of the column-shaped structure occupying a display area of the liquid crystal display element is 1 to 40%.

There will be explained below a method of manufacturing the column-shaped structure using polyester resin. For example, after a polyester resin solution is printed on a substrate where ITO electrodes formed with a predetermined pattern are preliminarily formed by using a printing machine such as a roll coater and a gravure coater, the printed solution is dried and cured so that column-shaped structures are formed on the substrate. In order to obtain a liquid crystal cell, the substrate on which the column-shaped structures are formed and another substrate are laminated in a state that they hold the column-shaped structures therebetween, and a liquid crystal composition may be injected between the substrates by the vacuum injecting method or the like. Alternatively, when the substrates are laminated, the liquid crystal composition is dropped, and the liquid crystal composition may be sealed simultaneously with the lamination of the substrates.

Further, in order to improve control accuracy of an inter-substrate gap, when the column-shaped structure is formed, spacer materials having smaller size than a film thickness of the column-shaped structure, such as glass fiber, ball-shaped glass and ceramic powder or spheric particles made of an organic material are arranged so that the gap is not changed by heating and pressurizing. As a result, the gap accuracy can be further improved, and accordingly irregularity of a voltage, irregularity of display and the like can be reduced.

Alternatively, the column-shaped structures 20 can be formed by the screen printing method. For instance, the following manner can be employed. Namely, a screen on which a predetermined pattern has been formed is placed over a surface of at least one substrate on which an electrodes or the like have been formed, and a printing material (a composition for forming the column-shaped structure such as photosensitive resin) is placed on the screen. A squeegee is moved by a predetermined pressure at predetermined angle and speed. As a result, the printing material is transferred onto the substrate via the pattern of the screen. Next, the transferred material is cured and dried.

In the case where the column-shaped structures are formed by the screen printing method, the resin material to be used is not limited to the above-mentioned photosensitive resin, and for example, thermoset resin or thermoplastic resin such as epoxy resin or acrylic resin can be also used. It is desirable that the resin material is obtained in a paste form by dissolving resin in a suitable solvent.

In the case where thermoset resin or thermoplastic resin is used as the resin material to be used for the column-shaped structures and the spacers are provided between a pair of substrates, for example, a liquid crystal cell can be manufactured in the following manner.

Namely, after the resin material is firstly placed on at least one substrate, the spacers are dispersed onto at least one substrate, and the paired substrates are overlapped with each other with surfaces formed with a plurality of strip-shaped electrodes are facing each other. The overlapped substrates are pressurized from both the sides and simultaneously heated so that the resin material is softened. The resin material is cooled to be again solidified, and an empty cell is formed. The liquid crystal composition may be injected into the empty cell between the substrates by the vacuum injecting method, for example.

(Operation of Element)

The transparent electrodes 13 and 14 are excited or powered by so-called simple matrix drive system so that the liquid crystal is brought into the planer state, the focal conic state or a state that they are mixed. The liquid crystal in the planer state selectively reflects a light in a specified wavelength range of the visible ray range and thus is observed as a colored state. The liquid crystal in the focal conic state transmits most of a light in the visible ray area and is observed as a transparent state. Since a light absorbing layer of black color is arranged on the back face of the element, the liquid crystal in the focal conic state is observed as a black state. When the respective liquid crystal display elements of red, green and blue are driven, full-color display is achieved by additive color mixture. These states are maintained also after application of a voltage is stopped (namely, having memory property).

As for the liquid crystal cells R1 and R2 which selectively reflect red, as shown in FIG. 1, one of a clockwise circular polarized light component and a counterclockwise circular polarized light component of a red wavelength light of an incident light to the liquid crystal cells is selectively reflected by the upper liquid crystal cell R2. The other circular polarized light component which has not been selectively reflected transmits through the liquid crystal cell R2 to reach the phase difference plate 26. Hereinafter, to ease the understanding, an explanation will be presented provided the clockwise circular polarized light component is set to be reflected in the upper liquid crystal cell R2.

When the counterclockwise polarized light component which reaches the phase difference plate 26 transmits through the phase difference plate 26, its phase shifts, and a light becomes the clockwise circular or elliptic polarized light. The clockwise circular or elliptic polarized light enters the lower liquid crystal cell R1. A red wavelength light of the entering light is selectively reflected by the lower liquid crystal cell R1 (a reflected light amount at this time depends on a degree of retardation of the phase difference plate 26).

The light which has been selectively reflected by the lower liquid crystal cell R1 transmits through the phase difference plate 26 again to become a counterclockwise circular or elliptic polarized light and pass through the upper element R2 (a transmitted light amount at this time depends on a degree of the retardation of the phase difference plate 26).

In such a manner, as for the red wavelength light of the incident light to the liquid crystal display element, both the clockwise and counterclockwise circular polarized light components can be selectively reflected by the liquid crystal cells R1 and R2, and the whole red wavelength light is switched on principle.

Meanwhile, since the liquid crystal cell B which is in the observing position and selectively reflects blue and the liquid crystal cell G which selectively reflects green have one-layer structure, respectively, for example, their contrast is not lowered in comparison with a two-layer structure which is the same as that of the liquid crystal cell for red display.

Therefore, reflection strength of the liquid crystal display element can be heightened without lowering the contrast. Moreover, since a reflectance from the liquid crystal cell for red display in the farthest position from the observing side is high, the color balance can be maintained satisfactorily.

According to the examination by the present inventors, in the case where only the liquid crystal cell for blue display has the two-layered structure and the liquid crystal cells for green and red display have the one-layered structure, it is proved that blue becomes too strong and the color balance is given away. Moreover, also in the case where the liquid crystal cells for blue and red display have the two-layered structure, it is proved that the color balance and the contrast are deteriorated.

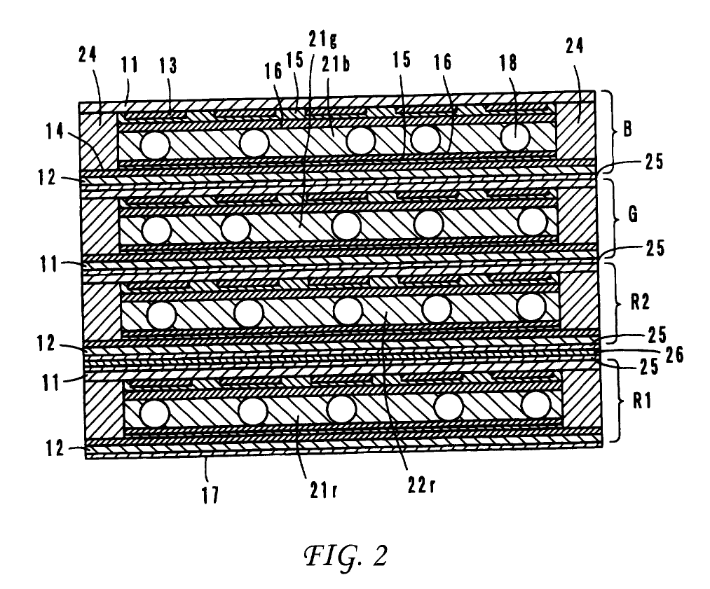

(Second Embodiment, see FIG. 2)

FIG. 2 shows a cross-sectional structure of a reflective full-color liquid crystal display element according to the second embodiment reflecting aspects of the present invention. This liquid crystal display element has the substantially same structure as the respective liquid crystal cells R1, R2, G and B shown in FIG. 1 except that the column-shaped structure is not provided in the display area. In FIG. 2, the same reference numerals are given to the components having the basically same structures and functions as those of the element shown in FIG. 1.

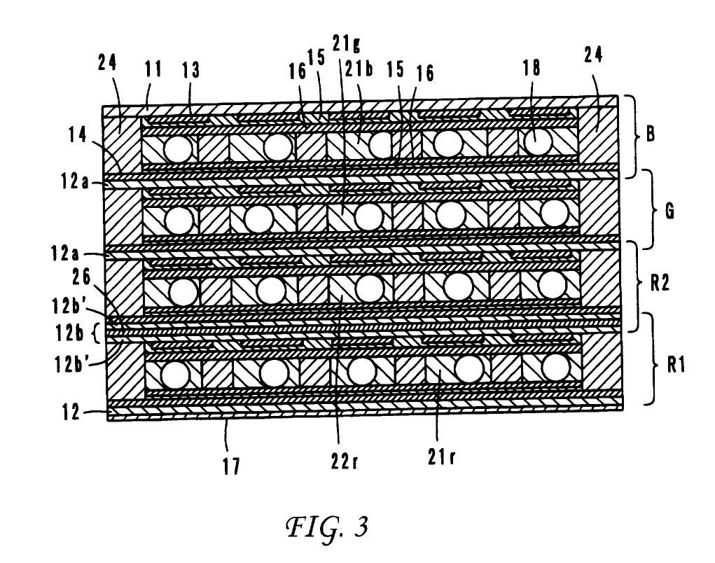

(Third Embodiment, see FIG. 3)

FIG. 3 shows a cross-sectional structure of the reflective full-color liquid crystal display element according to the third embodiment reflecting aspects of the present invention. This liquid crystal display element differs from the liquid crystal display element in FIG. 1 in that each of the three midst substrates 12a and 12b are used in common to the respective upper liquid crystal display cell and the respective lower liquid crystal display cell. Specifically, one substrate is used in common as the lower substrate of the liquid crystal cell B and the upper substrate of the liquid crystal cell G; one substrate is used in common as the lower substrate of the liquid crystal cell G and the upper substrate of the liquid crystal cell R2; and another one substrate is used in common as the lower substrate of the liquid crystal cell R2 and the upper substrate of the liquid crystal cell R1, respectively. The other structure is substantially the same as the structure of the liquid crystal cells R1, R2, G and B. In FIG. 3, the same reference numerals are given to the components having the basically same structures and functions as those of the element shown in FIG. 1.

In the respective liquid crystal cells R1, R2, G and B shown in FIG. 3, similarly to the substrates 11 and 12 shown in FIG. 1, the strip-shaped transparent electrodes 13 and 14 are formed only one surface of the upper substrate 11 of the liquid crystal cell B and one surface of the lower substrate 12 of the liquid crystal cell R1, and the insulating thin film 15 and the alignment stabilizing film 16 are provided. The strip-shaped transparent electrodes 13 and 14 are formed on upper and lower surfaces of the common substrates 12a and 12b positioned in the middle so as to cross each other, and the insulating thin film 15 and the alignment stabilizing film 16 are provided.

In addition, the common substrate 12b positioned between the liquid crystal cells R1 and R2 is obtained by thermally bonding the phase difference plate 26 between substrates 12b′, 12b′. The common substrate 12b may be laminated by adhesive instead of the thermal bonding.

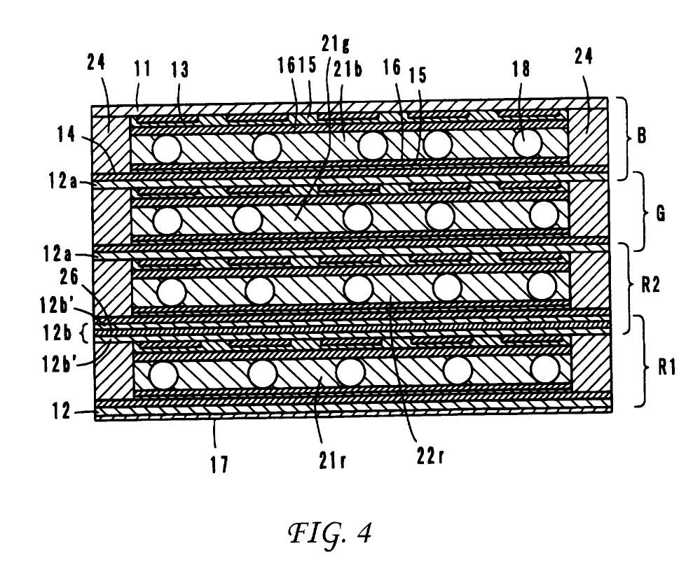

(Fourth Embodiment, see FIG. 4)

FIG. 4 shows a cross-sectional structure of a reflective full-color liquid crystal element according to the fourth embodiment reflecting aspects of the present invention. This liquid crystal display element has the substantially same structure as that of the liquid crystal cells R1, R2, G and B shown in FIG. 3 where some substrates are used in common except that the column-shaped structures are not provided in the display area. In FIG. 4, the same reference numerals are given to the components having the basically same structures and functions as those of the element shown in FIG. 3.

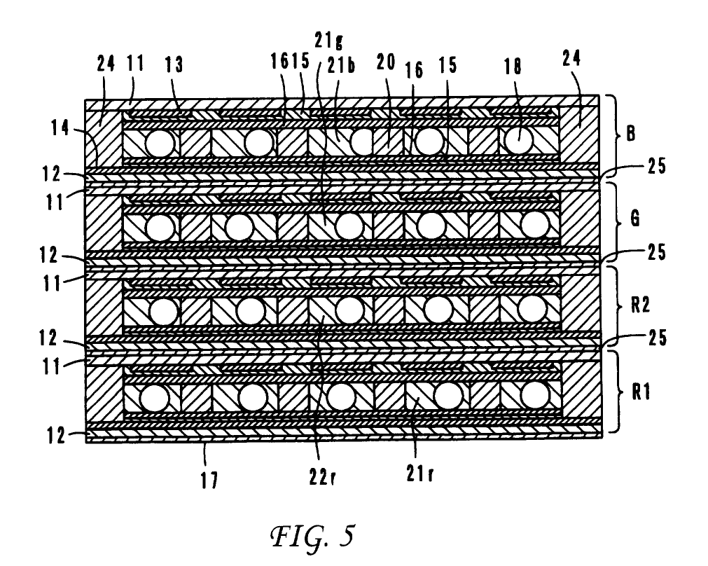

(Fifth to Eighth Embodiment, see FIGS. 5 to 8)

FIG. 5 shows a structure of a laminated-type liquid crystal display element (fifth embodiment) having the similar structure to that of the first embodiment except that a liquid crystal composition of liquid crystal cell R1 has a helical power opposing to that of a liquid crystal composition of liquid crystal cell R2 so that one of them selectively reflects a clockwise circular polarized light component while the remaining one selectively reflects a counterclockwise circular polarized light component and thus the phase difference plate is omitted.

In such a manner, when the two liquid crystal cells R1 and R2 for red display which selectively reflect the opposite circular polarized light components are used, since the liquid crystal cells R1 and R2 reflect the circular polarized lights which are opposite each other in circular direction, the phase difference plate is not necessary, and the reflectance of the red color can be increased.

Such a liquid crystal composition can be prepared by adding chiral materials having different optical rotating directions to the nematic liquid crystal. In the case where two layers having the opposite optical rotating directions are laminated, the laminating order is not particularly limited.

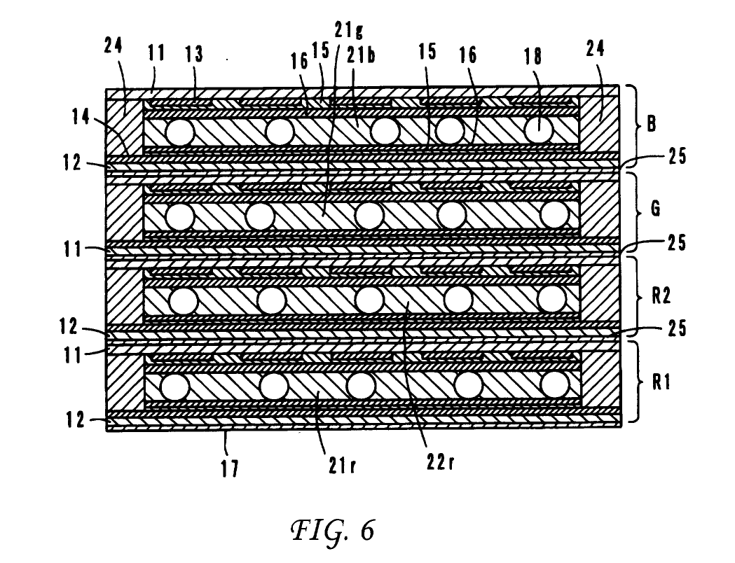

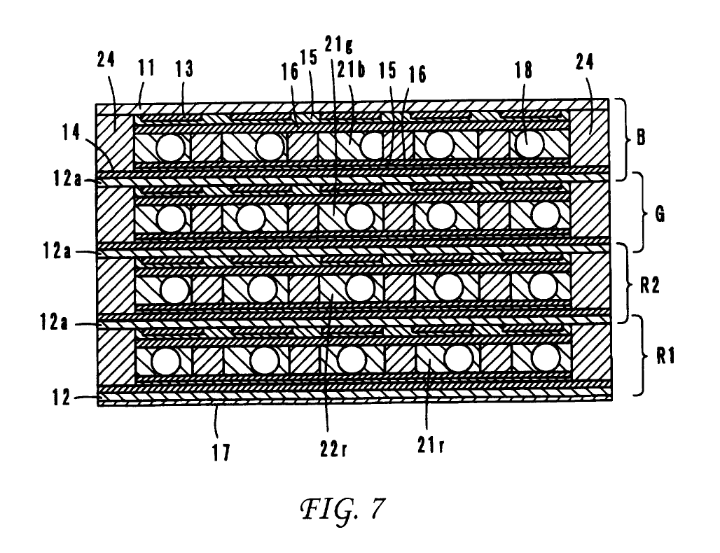

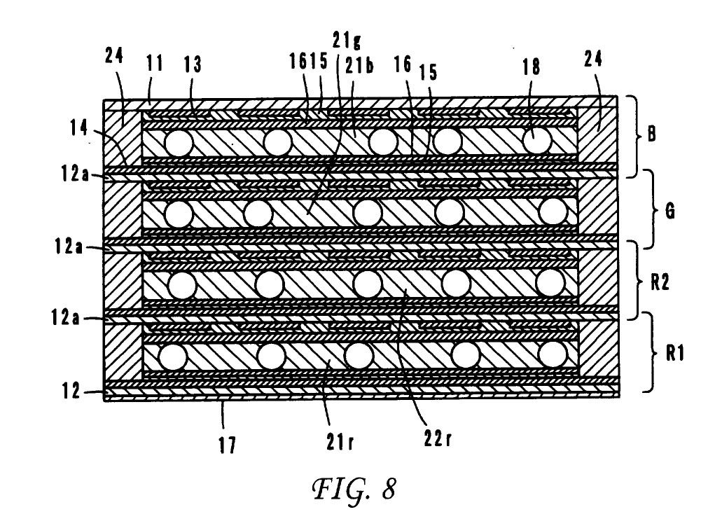

In addition, the liquid crystal cells R1 and R2 for red display having the relationship introduced in the fifth embodiment may be applied to the liquid crystal cells R1 and R2 for red display in the embodiments shown in FIGS. 2 through 4 (see FIGS. 6 to 8: FIG. 6 shows a sixth embodiment, FIG. 7 shows a seventh embodiment and FIG. 8 shows an eighth embodiment).

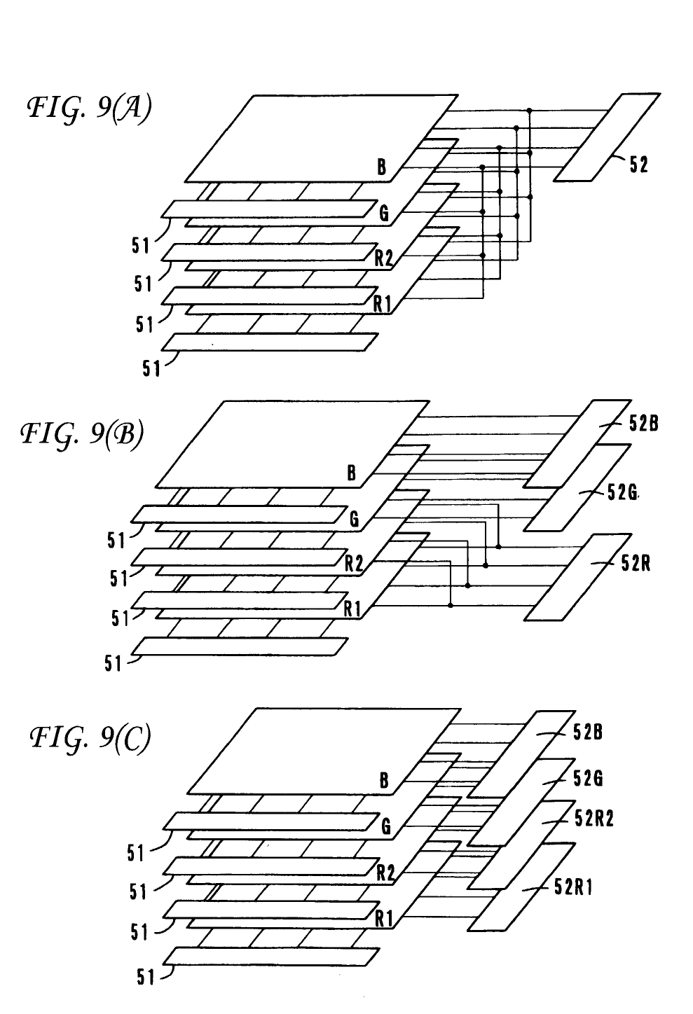

(Embodiments of Display Device, see FIGS. 9(a) through 9(C))

As shown in FIG. 9(A), one mode of the display device is such that signal electrode driving ICs 51 are provided to the liquid crystal cells, respectively, and a scanning electrode driving IC 52 is used in common for the respective liquid crystal cells. Namely, in the case where the drive voltages of the liquid crystal cells are approximately equal with one another, the scanning electrodes of the liquid crystal cells are electrically connected so as to be capable of being driven by the one scanning electrode driving IC 52. With this structure, the structure of the display device can be simplified, and a number of driving ICs to be used is less so that the cost can be reduced.

In another mode, only scanning electrode driving IC 52R may be used in common for the liquid crystal cells R1 and R for red display (see FIG. 9(B)). Particularly in the case where the phase difference plate is used, since the liquid crystal cells R1 and R2 have the completely same structure, such a structure can be easily adopted. Special scanning electrode driving ICs 52B and 52G may be provided for the liquid crystal cell B for blue display and the liquid crystal cell G for green display or one IC may be used in common.

Needless to say, scanning electrode driving ICs 52R1, 52R2, 52G and 52B can be arranged independently on all the liquid crystal cells (see FIG. 9(C)).

In addition, the signal electrode driving IC 51 may be used in common for the liquid crystal cells R1 and R2 for red display. In this case, a number of driving ICs to be used is less, and the cost can be reduced. On the contrary, like the above embodiment, independent signal electrode driving ICs 51 may be provided to the liquid crystal cells R1 and R2 for red display, respectively. In this case, both the ICs are combined to be driven so that gray scales which can be reproduced per pixel can be increased.

In any cases, setting the maximum driving voltage be not more than 45 V, it is practically effective since special high voltage driving IC is no more required. That is, a general low power driving IC can be used for the driving IC.

(Description of the Experimental Examples)

As for the reflective full-color liquid crystal display element of the present invention, elements of the following experimental examples were created and experiments were carried in their performance evaluations. There will be explained concretely below the evaluations of the experimental examples as well as those of the comparative examples. The liquid crystal display element of the present invention is not limited to these experimental examples.

In the following experimental examples and comparative examples, the reflective spectrophotometric colorimeter CM-3700d (made by Minolta Co., Ltd.) was used to measure reflectance, Y value (luminous reflectance) and chromaticity of the liquid crystal display element under a condition that a distance between a liquid crystal cell and an opening was 6 mm. The chromaticity of a white point showing satisfactory display property (x, y)=(0.31, 0.33), and as the chromaticity of the display element is closer to this coordinate, the white property is more satisfactory. Moreover, as the Y value is smaller, the element is more transparent, and as the Y value is larger, it is brighter. The contrast is obtained by (Y value in the state of high reflectance/Y value in the state of low reflectance). In the liquid crystal display elements of the experimental examples and comparative examples explained below, when the liquid crystal is in the planer state, the element is in the states of high reflectance (colored), and when the liquid crystal is in the focal conic state, the element is in the state of low reflectance (transparent).

Further, refractive index anisotropy was measured by Abbe refractometer. A liquid crystal cell with a vertical alignment stabilizing film and a liquid crystal cell without alignment stabilizing film were used, and their electrostatic capacities and an electrostatic capacities of empty cells were measured by an impedance analyzer so that dielectric constant anisotropy was calculated by the ratio of the electrostatic capacities. The measurement was carried out at 25° C. with 1 kHz by impedance analyzer 4192A (available from Hewlett-Packard Japan Ltd.).

### FIRST EXPERIMENTAL EXAMPLE

For preparing the liquid crystal compositions 21r, 22r, 21g and 21b, a chiral material S-811(available from Merck & Co.) is added to a nematic liquid crystal mixture A (refractive index anisotropy Δn: 0.210, dielectric constant anisotropy Δε: 38.7, nematic isotropic phase change temperature T_{NI}: 119° C.) so that the chiral material S-811 is to be 21% by weight, 21% by weight, 26% by weight and 36% by weight with respect to a total weight of the nematic liquid crystal mixture and the chiral material, respectively. The liquid crystal compositions 21r and 22r have a peak wavelength of selective reflection in the vicinity of 680 nm, the liquid crystal composition 21g has a peak wavelength in the vicinity of 560 nm, and the liquid crystal composition 21b has a peak wavelength in the vicinity of 480 nm.

Next, after an insulating thin film made of HIM3000 (available from Hitachi Chemical Co., Ltd.) was formed into a thickness of 2000 Å on transparent electrodes provided on a first substrate made of a polycarbonate film, an alignment stabilizing film made of soluble polyimide was formed into a thickness of 800 Å. Similarly to the first substrate, an insulating thin film and an alignment stabilizing film were formed on transparent electrodes provided onto a second substrate made of a polycarbonate film.

A sealing material XN21S (available from Mitsui Chemicals Inc.) was screen-printed around the first substrate so that a wall with predetermined height was formed. Thereafter, fixing spacers with a diameter of 6 μm (available from Sekisui Chemical Co., Ltd.) were dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the above steps. These liquid crystal cells were laminated in the order of R1, R2, G and B from the bottom, and a phase difference plate was inserted between the liquid crystal cells R1 and R2, and the respective liquid crystal cells were fixed to one another by transparent adhesive. Further, a light absorbing layer of black color was provided to the substrate on the opposite side to the light incident side (rear face of the lower substrate of the cell R1). In such a manner, the laminated-type liquid crystal display element having the structure shown in FIG. 2 was prepared.

In such a liquid crystal display element, when a pulse voltage of 40 V was applied for 5 msec., after 2 msec. a pulse voltage of 25V was applied for 2 msec., and after 2 msec. a pulse voltage of 25V was applied for 2 msec. between the electrodes of the respective liquid crystal cells, the liquid crystal cells were brought into the transparent state (focal conic state), and when the four layers were in the transparent state and in the black display state, the luminous reflectance Y was 3.5. Moreover, when a pulse voltage of 40 V was applied for 5 msec., after 2 msec. a pulse voltage of 50 V was applied for 2 msec. and after 2 msec. a pulse voltage of 40 V was applied for 2 msec. between the electrodes of the liquid crystal cells, the liquid crystal cells were brought into a colored state (planer state). When the four layers were in the colored state and in the white display state, the luminous reflectance Y was 45.6, and the contrast was 13.0:1. Moreover, the chromaticity at the time of white display (x, y)=(0.31, 0.34), and the reflectance was 63.4%, and the liquid crystal display element had good white chromaticity and high contrast. Further, it had wide color reproducing range and less irregularity of display and showed good display property.

### SECOND EXPERIMENTAL EXAMPLE

For preparing each of the liquid crystal compositions 21r, 21g and 21b, a chiral material S-811 is added to a mixture of a nematic liquid crystal mixture B (Δn: 0.212, Δε: 40.2, T_{NI}: 103° C.), a nematic liquid crystal mixture C (Δn: 0.210, Δε: 38.7, T_{NI}: 119° C.) and a nematic liquid crystal mixture D (Δn: 0.214, Δε: 27.6, T_{NI}: 143° C.) so that the chiral material S-811 is to be 22% by weight (liquid crystal composition 21r), 27% by weight (liquid crystal composition 21g) and 35% by weight (liquid crystal composition 21b) with respect to a total weight of all the nematic liquid crystal mixtures and the chiral material, respectively. For preparing the liquid crystal composition 22r, a chiral material R-811 (available from Merck & Co.) is added to the mixture of the nematic liquid crystal mixtures B, C and D so that the chiral material R-811 is to be 22% by weight with respect to a total weight of all the nematic liquid crystal mixtures and the chiral material, respectively. The liquid crystal compositions 21r and 22r have a peak wavelength of selective reflection in the vicinity of 670 nm, the liquid crystal composition 21g has a peak wavelength in the vicinity of 570 nm, and the liquid crystal composition 21b has a peak wavelength in the vicinity of 470 nm. S-811 and R-811 are the chiral materials having the opposite optical rotating directions. Therefore, the liquid crystal compositions 21r and 22r selectively reflect opposite circular polarized light components.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 500 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed. Thereafter, fixing spacers with a diameter of 6 μm (made by Sekisui Finechemical Co., Ltd.) was dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the above steps. These liquid crystal cells were laminated in the order of R1, R2, G and B from the bottom, and the respective liquid crystal cells were fixed to one another by transparent adhesive. Further, a light absorbing layer of black color was provided to the substrate on the opposite side to the light incident side (rear face of the lower substrate of the cell R1). In such a manner, the laminated-type liquid crystal display element having the structure shown in FIG. 6 was prepared.

In such a liquid crystal display element, when a pulse voltage of 38 V was applied for 5 msec., after 2 msec. a pulse voltage of 23V was applied for 2 msec., and after 2 msec. a pulse voltage of 23V was applied for 2 msec. between the electrodes of the respective liquid crystal cells, the liquid crystal cells were brought into the transparent state (focal conic state), and when the four layers were in the transparent state and in the black display state, the luminous reflectance Y was 3.6. Moreover, when a pulse voltage of 38 V was applied for 5 msec., after 2 msec. a pulse voltage of 38 V was applied for 2 msec. and after 2 msec. a pulse voltage of 38 V was applied for 2 msec. between the electrodes of the liquid crystal cells, the liquid crystal cells were brought into a colored state (planer state). When the four layers were in the colored state and in the white display state, the luminous reflectance Y was 47.5, and the contrast was 13.2: 1. Moreover, the chromaticity at the time of white display (x, y)=(0.31, 0.34), and the reflectance was 64.5%, and the liquid crystal display element had good white chromaticity and high contrast. Further, it had wide color reproducing range and less irregularity of display and showed good display property.

### THIRD EXPERIMENTAL EXAMPLE

Chiral materials S-811, which are 23% by weight, 23% by weight, 27% by weight and 37% by weight with respect to a total weight of all the liquid crystal mixtures and a chiral material, were added to a mixture of a nematic liquid crystal mixture E (Δn: 0.212, Δε: 31, T_{NI}: 103° C.), a nematic liquid crystal mixture F (Δn: 0.210, Δε: 28.7, T_{NI}: 119° C.) and a nematic liquid crystal mixture G (Δn: 0.214, Δε: 27.6, T_{NI}: 143° C.). As a result, a liquid crystal composition 21r, a liquid crystal composition 22r, a liquid crystal composition 21g and a liquid crystal composition material 21b were prepared, respectively. The liquid crystal compositions 21r and 22r have a peak wavelength of selective reflection in the vicinity of 655 nm, the liquid crystal composition 21g has a peak wavelength in the vicinity of 550 nm, and the liquid crystal composition 21b has a peak wavelength in the vicinity of 455 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 800 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed, and epoxy resin was screen printed so that column-shaped structures were formed inside area framed by the wall. Thereafter, fixing spacers with a diameter of 6 μm (made by Sekisui Finechemical Co., Ltd.) were dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the above steps. These liquid crystal cells were laminated in the order of R1, R2, G and B from the bottom, and a phase difference plate was inserted between the liquid crystal cells R1 and R2, and the respective liquid crystal cells were fixed to one another by transparent adhesive. Further, a light absorbing layer of black color was provided to the substrate on the opposite side to the light incident side (rear face of the lower substrate of the cell R1). In such a manner, the laminated-type liquid crystal display element having the structure shown in FIG. 1 was prepared.

In such a liquid crystal display element, when a pulse voltage of 42 V was applied for 5 msec., after 2 msec. a pulse voltage of 28V was applied for 2 msec., and after 2 msec. a pulse voltage of 28V was applied for 2 msec. between the electrodes of the respective liquid crystal cells, the liquid crystal cells were brought into the transparent state (focal conic state), and when the four layers were in the transparent state and in the black display state, the luminous reflectance Y was 3.4. Moreover, when a pulse voltage of 42 V was applied for 5 msec., after 2 msec. a pulse voltage of 42 V was applied for 2 msec. and after 2 msec. a pulse voltage of 42 V was applied for 2 msec. between the electrodes of the liquid crystal cells, the liquid crystal cells were brought into a colored state (planer state). When the four layers were in the colored state and in the white display state, the luminous reflectance Y was 44.2, and the contrast was 13.0: 1. Moreover, the chromaticity at the time of white display (x, y)=(0.31, 0.35), and the reflectance was 62.8%, and the liquid crystal display element had good white chromaticity and high contrast. Further, it had wide color reproducing range and less irregularity of display and showed good display property.

### FOURTH EXPERIMENTAL EXAMPLE

A chiral material R-811, which is 20% by weight with respect to a total weight of a liquid crystal mixture and a chiral material, was added to a nematic liquid crystal mixture H (Δn: 0.204, Δε: 25.4, T_{NI}: 91.7° C.) so that a liquid crystal composition 21r was prepared. 20% by weight of a chiral material S-811 was added to the nematic liquid crystal mixture H so that a liquid crystal composition 22r was prepared. 28% by weight of the chiral material S-811 was added to the nematic liquid crystal mixture H so that a liquid crystal composition 21g was prepared. 39% by weight of the chiral material S-811 was added to the nematic liquid crystal mixture H so that a liquid crystal composition material 21b was prepared. The liquid crystal compositions 21r and 22r have a peak wavelength of selective reflection in the vicinity of 660 nm, the liquid crystal composition 21g has a peak wavelength in the vicinity of 580 nm, and the liquid crystal composition 21b has a peak wavelength in the vicinity of 485 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 500 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed, and epoxy resin was screen-printed inside area framed by the wall so that column-shaped structures were formed. Thereafter, fixing spacers with a diameter of 5 μm (made by Sekisui Finechemical Co., Ltd.) were dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the above steps. These liquid crystal cells were laminated in the order of R1, R2, G and B from the bottom, and the respective liquid crystal cells were fixed to one another by transparent adhesive. Further, a black light absorbing layer was provided to the substrate on the opposite side to the light incident side (rear face of the lower substrate of the cell R1). In such a manner, the laminated-type liquid crystal display element having the structure shown in FIG. 5 was prepared.

In such a liquid crystal display element, when a pulse voltage of 45 V was applied for 5 msec., after 2 msec. a pulse voltage of 30V was applied for 2 msec., and after 2 msec. a pulse voltage of 30V was applied for 2 msec. between the electrodes of the respective liquid crystal cells, the liquid crystal cells were brought into the transparent state (focal conic state), and when the four layers were in the transparent state and in the black display state, the luminous reflectance Y was 3.5. Moreover, when a pulse voltage of 45 V was applied for 5 msec., after 2 msec. a pulse voltage of 45 V was applied for 2 msec. and after 2 msec. a pulse voltage of 45 V was applied for 2 msec. between the electrodes of the liquid crystal cells, the liquid crystal cells were brought into a colored state (planer state). When the four layers were in the colored state and in the white display state, the luminous reflectance Y was 45.9, and the contrast was 13.1: 1. Moreover, the chromaticity at the time of white display (x, y)=(0.32, 0.33), and the reflectance was 64.3%, and the liquid crystal display element had good white chromaticity and high contrast. Further, it had wide color reproducing range and less irregularity of display and showed good display property.

### FIFTH EXPERIMENTAL EXAMPLE

A chiral material R-811 and a chiral material R-1011 (available from Merck & Co.), which are 18% by weight and 3% by weight, respectively, with respect to a total weight of a liquid crystal mixture and chiral materials, were added to a nematic liquid crystal mixture I (Δn: 0.213, Δε: 26.8, T_{NI}: 101.5° C.) so that a liquid crystal composition was prepared. Further, 0.8% by weight of a red dyestuff S1426 (available from Mitsui Chemicals Inc.) was mixed with the liquid crystal composition so that a liquid crystal composition 21r was prepared. The liquid crystal composition 21r has a peak wavelength of selective reflection in the vicinity of 685 nm.

Further, a chiral material S-811 and a chiral material S-1011 (available from Merck & Co.), which are 18% by weight and 3% by weight, respectively, with respect to a total weight of a liquid crystal mixture and chiral materials, were added to the nematic liquid crystal mixture I so that a liquid crystal composition was prepared. Further, 0.8% by weight of the red dyestuff S1426 was mixed with the liquid crystal composition so that a liquid crystal composition 22r was prepared. The liquid crystal composition 22r has a peak wavelength of selective reflection in the vicinity of 685 nm.

Further, a chiral material CB-15 (available from Merck & Co.), which is 34.8% by weight with respect to a total weight of a liquid crystal mixture and a chiral material, was added to a nematic liquid crystal mixture J (Δn: 0.218, Δε: 21.3, T_{NI}: 102° C.) so that a liquid crystal composition was prepared. Further, 0.6% by weight of yellow dyestuff YellowGN (made by Nippon Kayaku Co., Ltd.) was mixed with the liquid crystal composition so that a liquid crystal composition 21g was prepared. The liquid crystal composition 21g has a peak wavelength of selective reflection in the vicinity of 585 nm.

Further, the chiral material CB-15 and the chiral material S-811, which are 32% by weight and 8% by weight, respectively, with respect to a total weight of a liquid crystal mixture and chiral materials, were added to a nematic liquid crystal mixture K (Δn: 0.177, Δε: 19.0, T_{NI}: 103° C.) so that a liquid crystal composition 21b was prepared. The liquid crystal composition 21b has a peak wavelength of selective reflection in the vicinity of 470 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 500 Å. The alignment stabilizing film was rubbed weakly. As for the rubbing conditions, a number of revolutions of a roller around which a rayon rubbing cloth was wound was 70 rpm, a relative moving speed of the rubbing roller with respect to the plastic substrate formed with the alignment stabilizing film was 180 cm/min., and a pushing amount of a pile of the rubbing cloth was 0.2 mm.

Thereafter, similarly to the first substrate, an insulating thin film and an alignment stabilizing film are formed on transparent electrodes provided onto a second substrate made of a polycarbonate film. This alignment stabilizing film was not rubbed.

A sealing material XN21S was screen-printed around the first substrate so that a wall with predetermined height was formed, and epoxy resin was screen-printed inside the wall so that column-shaped structures was formed. Thereafter, fixing spacers with a diameter of 5 μm (made by Sekisui Finechemical Co., Ltd.) was dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the above steps. These liquid crystal cells were laminated in the order of R1, R2, G and B from the bottom, and the respective liquid crystal cells were fixed to one another by transparent adhesive. Further, a black light absorbing layer was provided to the substrate on the opposite side to the light incident side (rear face of the lower substrate of the cell R1). In such a manner, the laminated-type liquid crystal display element having the structure shown in FIG. 5 was prepared.

In such a liquid crystal display element, when a pulse voltage of 40 V was applied for 5 msec., after 2 msec. a pulse voltage of 23 V was applied for 2 msec., and after 2 msec. a pulse voltage of 23 V was applied for 2 msec. between the electrodes of the respective liquid crystal cells, the liquid crystal cells were brought into the transparent state (focal conic state), and when the four layers were in the transparent state and in the black display state, the luminous reflectance Y was 4.0. Moreover, when a pulse voltage of 40 V was applied for 5 msec., after 2 msec. a pulse voltage of 40 V was applied for 2 msec. and after 2 msec. a pulse voltage of 40 V was applied for 2 msec. between the electrodes of the liquid crystal cells, the liquid crystal cells were brought into a colored state (planer state). When the four layers were in the colored state and in the white display state, the luminous reflectance Y was 54.7, and the contrast was 13.7 : 1. Moreover, the chromaticity at the time of white display (x, y)=(0.31, 0.34), and the reflectance was 70.4%, and the liquid crystal display element had good white chromaticity and high contrast. Further, it had wide color reproducing range and less irregularity of display and showed good display property.

### SIXTH EXPERIMENTAL EXAMPLE

A chiral material R-811 and a chiral material R-1011, which are 19% by weight and 3.5% by weight, respectively, with respect to a total weight of a liquid crystal mixture and chiral materials, were added to a nematic liquid crystal mixture L (Δn: 0.195, Δε: 22.5, T_{NI}: 107.5° C.) so that a liquid crystal composition was prepared. Further, 0.6% by weight of a red dyestuff S1426 was mixed with the liquid crystal composition so that a liquid crystal composition 21r was prepared. The liquid crystal composition 21r has a peak wavelength of selective reflection in the vicinity of 670 nm.

Further, a chiral material S-811 and a chiral material S-1011, which are 19% by weight and 3.5% by weight, respectively, with respect to a total weight of a liquid crystal mixture and chiral materials, were added to the nematic liquid crystal mixture L so that a liquid crystal composition was prepared. Further, 0.6% by weight of the red dyestuff S1426 was mixed with the liquid crystal composition so that a liquid crystal composition 22r was prepared. The liquid crystal composition 22r has a peak wavelength of selective reflection in the vicinity of 670 nm.

Further, a chiral material CB-15, which is 34.2% by weight with respect to a total weight of a liquid crystal mixture and a chiral material, was added to a nematic liquid crystal mixture M (Δn: 0.203, Δε: 25.1, T_{NI}: 105° C.) so that a liquid crystal composition was prepared. Further, 0.4% by weight of yellow dyestuff YellowGN was mixed with the liquid crystal composition so that a liquid crystal composition 21g was prepared. The liquid crystal composition 21g has a peak wavelength of selective reflection in the vicinity of 565 nm.

Further, the chiral material CB-15 and the chiral material S-811, which are 30% by weight and 7.6% by weight, respectively, with respect to a total weight of a liquid crystal mixture and chiral materials, were added to a nematic liquid crystal mixture N (Δn: 0.196, Δε: 23.2, T_{NI}: 101.6° C.) so that a liquid crystal composition 21b was prepared. The liquid crystal composition 21b has a peak wavelength of selective reflection in the vicinity of 480 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 500 Å. The alignment stabilizing film was rubbed weakly. As for the rubbing conditions, a number of revolutions of a roller around which a rayon rubbing cloth was wound was 70 rpm, a relative moving speed of the rubbing roller with respect to the plastic substrate formed with the alignment stabilizing film was 180 cm/min., and a pushing amount of a pile of the rubbing cloth was 0.2 mm.

Thereafter, similarly to the first substrate, an insulating thin film and an alignment stabilizing film are formed on a transparent electrode provided onto a second substrate made of a polycarbonate film. This alignment stabilizing film was not rubbed.

A sealing material XN21S was screen-printed around the first substrate so that a wall with predetermined height was formed, and epoxy resin was screen-printed inside the wall so that column-shaped structures were formed. Thereafter, fixing spacers with a diameter of 5 μm (made by Sekisui Finechemical Co., Ltd.) were dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells R2, G and B in which the liquid crystal compositions 22r, 21g and 21b are held between the substrates were obtained by the same steps as the above steps except that the alignment stabilizing film of the first substrate is not rubbed. These liquid crystal cells were laminated in the order of R1, R2, G and B from the bottom, and the respective liquid crystal cells were fixed to one another by transparent adhesive. Further, a black light absorbing layer was provided to the substrate on the opposite side to the light incident side (rear face of the lower substrate of the cell R1). In such a manner, the laminated-type liquid crystal display element having the structure shown in FIG. 5 was prepared.

In such a liquid crystal display element, when a pulse voltage of 40 V was applied for 5 msec., after 2 msec. a pulse voltage of 25 V was applied for 2 msec., and after 2 msec. a pulse voltage of 25 V was applied for 2 msec. between the electrodes of the respective liquid crystal cells, the liquid crystal cells were brought into the transparent state (focal conic state), and when the four layers were in the transparent state and in the black display state, the luminous reflectance Y was 3.7. Moreover, when a pulse voltage of 40 V was applied for 5 msec., after 2 msec. a pulse voltage of 40 V was applied for 2 msec. and after 2 msec. a pulse voltage of 40 V was applied for 2 msec. between the electrodes of the liquid crystal cells, the liquid crystal cells were brought into a colored state (planer state). When the four layers were in the colored state and in the white display state, the luminous reflectance Y was 50.0, and the contrast was 13.5: 1. Moreover, the chromaticity at the time of white display (x, y)=(0.31, 0.33), and the reflectance was 66.5%, and the liquid crystal display element had good white chromaticity and high contrast. Further, it had wide color reproducing range and less irregularity of display and showed good display property.

### FIRST COMPARATIVE EXAMPLE

Chiral materials S-811, which are 21% by weight, 26% by weight and 36% by weight with respect to a total weight of the liquid crystal mixture and the chiral material, were added to the nematic liquid crystal mixture A used in the first embodiment 1, so that a liquid crystal composition 21r, a liquid crystal composition 21g and a liquid crystal composition 21b were prepared, respectively. The liquid crystal composition 21r has a peak wavelength of selective reflection in the vicinity of 680 nm, the liquid crystal composition 21g has a peak wavelength in the vicinity of 560 nm, and the liquid crystal composition 21b has a peak wavelength in the vicinity of 480 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 800 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed. Thereafter, fixing spacer with a diameter of 6 μm (made by Sekisui Finechemical Co., Ltd.) was dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells G and B in which the liquid crystal compositions 21g and 21b are held between the substrates were obtained by the above steps. These liquid crystal cells were laminated in the order of R1, G and B from the bottom, and the respective liquid crystal cells were fixed to one another by transparent adhesive. Further, a black light absorbing layer was provided to the substrate on the opposite side to the light incident side (rear face of the lower substrate of the cell R1).

In such a liquid crystal display element, when a pulse voltage of 40 V was applied for 5 msec., after 2 msec. a pulse voltage of 25 V was applied for 2 msec., and after 2 msec. a pulse voltage of 25 V was applied for 2 msec. between the electrodes of the respective liquid crystal cells, the liquid crystal cells were brought into the transparent state (focal conic state), and when the three layers were in the transparent state and in the black display state, the luminous reflectance Y was 3.3. Moreover, when a pulse voltage of 40 V was applied for 5 msec., after 2 msec. a pulse voltage of 50 V was applied for 2 msec. and after 2 msec. a pulse voltage of 40 V was applied for 2 msec. between the electrodes of the liquid crystal cells, the liquid crystal cells were brought into a colored state (planer state). When the three layers were in the colored state and in the white display state, the luminous reflectance Y was 35.3, and the contrast was 10.7 : 1 Moreover, the chromaticity at the time of white display (x, y)=(0.32, 0.37), and the reflectance was 46.7%, and the liquid crystal display element had lower white chromaticity and lower contrast than those of the above respective examples. Further, red display was darker than that of the examples and color balance was not good. The color reproducing range became narrower than that of the examples.

### SECOND COMPARATIVE EXAMPLE

Chiral materials S-811, which were 21% by weight, 26% by weight and 36% by weight with respective to a total amount of the liquid crystal mixture and the chiral material, were added to the nematic liquid crystal mixture A used in the first embodiment 1, so that a liquid crystal composition 21r, a liquid crystal composition 21g and a liquid crystal composition 21b were prepared, respectively. The liquid crystal composition 21r has a peak wavelength of selective reflection in the vicinity of 680 nm, the liquid crystal composition 21g has a peak wavelength in the vicinity of 560 nm, and the liquid crystal composition 21b has a peak wavelength in the vicinity of 480 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 800 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed. Thereafter, fixing spacers with a diameter of 9 μm (made by Sekisui Finechemical Co., Ltd.) was dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells G and B in which the liquid crystal compositions 21g and 21b are held between the substrates were obtained by the same steps as the above steps except that fixing spacers with a diameter of 6 μm (made by Sekisui Finechemical Co., Ltd.) was dispersed onto the second substrate. These liquid crystal cells were laminated in the order of R1, G and B from the bottom, and the respective liquid crystal cells were fixed to one another by transparent adhesive. Further, a black light absorbing layer was provided to the substrate on the opposite side to the light incident side (rear face of the lower substrate of the cell R1).

In such a liquid crystal display element, when a pulse voltage of 65 V was applied for 5 msec., after 2 msec. a pulse voltage of 35 V was applied for 2 msec., and after 2 msec. a pulse voltage of 35 V was applied for 2 msec. between the electrodes of the liquid crystal cell R1, the liquid crystal cell was brought into the transparent state (focal conic state). When a pulse voltage of 40 V was applied for 5 msec., after 2 msec. a pulse voltage of 25 V was applied for 2 msec. and after 2 msec. a pulse voltage of 25 V was applied for 2 msec. between the electrodes of the liquid crystal cells G and B, the liquid crystal cells were brought into the transparent state (focal conic state). When the three layers are in the transparent and in the black display state, the luminous reflectance Y was 3.6. Moreover, When a pulse voltage of 65 V was applied for 5 msec., after 2 msec. a pulse voltage of 65 V was applied for 2 msec. and after 2 msec. a pulse voltage of 65 V was applied for 2 msec. between the electrodes of the liquid crystal cell R1, the liquid crystal cell was brought into the colored state (planer state). When a pulse voltage of 40 V is applied for 5 msec., after 2 msec. a pulse voltage of 40 V was applied for 2 msec., and after 2 msec. a pulse voltage of 40 V was applied for 2 msec. between the electrodes of the liquid crystal cells G and B, the liquid crystal cells were brought into the colored state (planer state). When the three layers were in the colored state and in the white display state, the luminous reflectance Y was 41.5, and the contrast was 11.5: 1. Moreover, the chromaticity at the time of white display (x, y)=(0.31, 0.35), and the reflectance was 54.9%, and the liquid crystal display element had satisfactory white chromaticity, but lower contrast than those of the above respective examples. Further, the liquid crystal cell R1 was driven by the same condition as that of the liquid crystal cells B and G, the color reproducing range of the liquid crystal cell R1 could not be realized sufficiently, and white color balance was defective (namely, the three layers could not be driven by the same voltage).

### THIRD COMPARATIVE EXAMPLE

Chiral materials S-811, which were 21% by weight, 26% by weight, 26% by weight and 36% by weight with respective to a total amount of the liquid crystal mixture and the chiral material, were added to the nematic liquid crystal mixture A used in the first embodiment 1, so that a liquid crystal composition 21r, a liquid crystal composition 21g, a liquid crystal composition 22g and a liquid crystal composition 21b were prepared, respectively. The liquid crystal composition 21r has a peak wavelength of selective reflection in the vicinity of 680 nm, the liquid crystal compositions 21g and 22g have a peak wavelength in the vicinity of 560 nm, and the liquid crystal composition 21b has a peak wavelength in the vicinity of 480 nm.

Next, after an insulating thin film made of HIM3000 was formed into a thickness of 2000 Å on transparent electrodes provided on a first substrate made of a polycarbonate film, an alignment stabilizing film made of soluble polyimide was formed into a thickness of 800 Å. Similarly to the first substrate, an insulating thin film and an alignment stabilizing film were formed on transparent electrodes provided onto a second substrate made of a polycarbonate film.

A sealing material XN21S was screen-printed around the first substrate so that a wall with predetermined height was formed. Thereafter, fixing spacers with a diameter of 6 μm (made by Sekisui Finechemical Co., Ltd.) were dispersed onto the second substrate. The liquid crystal composition 21r of an amount calculated from the height and area of inside the wall of the sealing material was applied onto the first substrate, and the first substrate and the second substrate are laminated by a laminating apparatus, and they were heated at 150° C. for 1 hour so that the liquid crystal cell R1 was obtained.

The liquid crystal cells G1, G2 and B in which the liquid crystal compositions 21g, 22g and 21b are held between the substrates were obtained by the above step. These liquid crystal cells were laminated in the order of R1, G1, G2 and B from the bottom, a phase difference plate was inserted into the liquid crystal cells G1 and G2, and the respective liquid crystal cells were fixed to one another by transparent adhesive. Further, a black light absorbing layer was provided to the substrate on the opposite side to the light incident side (rear face of the lower substrate of the cell R1).

In such a liquid crystal display element, when a pulse voltage of 40 V was applied for 5 msec., after 2 msec. a pulse voltage of 25 V was applied for 2 msec., and after 2 msec. a pulse voltage of 25 V was applied for 2 msec. between the electrodes of the respective liquid crystal cells, the liquid crystal cells were brought into the transparent state (focal conic state), and when the four layers were in the transparent state and in the black display state, the luminous reflectance Y was 3.6. Moreover, when a pulse voltage of 40 V was applied for 5 msec., after 2 msec. a pulse voltage of 40 V was applied for 2 msec., and after 2 msec. a pulse voltage of 40 V was applied for 2 msec. between the electrodes of the respective liquid crystal cells, the liquid crystal cells were in the colored state and in the white display state, the luminous reflectance Y was 45.8, and the contrast was 12.7: 1. Moreover, the chromaticity at the time of white display (x, y)=(0.34, 0.35), and the reflectance was 60.5%. The liquid crystal display element had comparatively high contrast, but had worse white chromaticity than those of the above respective examples. Further, since green was dark, the color balance was not good. The color reproducing range became narrower than those of the examples.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A layered type reflective color liquid crystal display element comprising from an observation side:
a single layer of a liquid crystal cell which comprises a chiral nematic liquid crystal composition for selectively reflecting blue color;
a single layer of a liquid crystal cell which comprises a chiral nematic liquid crystal composition for selectively reflecting green color; and
two layers of liquid crystal cells each of which comprises a chiral nematic liquid crystal composition for selectively reflecting red color.

2. The layered type reflective color liquid crystal display element as claimed in claim 1, wherein each of the liquid crystal cells has a gap in which the respective liquid crystal composition is filled.

3. The layered type reflective color liquid crystal display element as claimed in claim 2, wherein each of the gaps has a thickness in a range from 3 μm to 10 μm.

4. The layered type reflective color liquid crystal display element as claimed in claim 3, wherein each of the gaps has a thickness in a range from 3 μm to 6 μm.

5. The layered type reflective color liquid crystal display element as claimed in claim 3, wherein the gaps are substantially the same in the thickness.

6. The layered type reflective color liquid crystal display element as claimed in claim 2, wherein each of the gaps is formed between a pair of substrates.

7. The layered type reflective color liquid crystal display element as claimed in claim 6, wherein each of gaps has a thickness defined by spacers dispersed between the respective one pair of substrates.

8. The layered type reflective color liquid crystal display element as claimed in claim 6, wherein at least one of the substrates is shared by one of the liquid crystal cell and a neighboring one of the liquid crystal cell.

9. The layered type reflective color liquid crystal display element as claimed in claim 6, wherein, in at least one of the liquid crystal cells, a plurality of resin columnar structures are formed between the pair of substrates.

10. The layered type reflective color liquid crystal display element as claimed in claim 6, wherein, in at least one of the liquid crystal cells, one of the pair of substrates has been subjected to a rubbing treatment.

11. The layered type reflective color liquid crystal display element as claimed in claim 10, wherein a rubbing density is not more than 20.

12. The layered type reflective color liquid crystal display element as claimed in claim 6, wherein, in at least one of the liquid crystal cells, at least one of the substrates is made of a resin material.

13. The layered type reflective color liquid crystal display element as claimed in claim 1, wherein, in at least one of the liquid crystal cells, the liquid crystal composition has a refractive anisotropy Δn in a range from 0.13 to 0.22.

14. The layered type reflective color liquid crystal display element as claimed in claim 1, wherein, in at least one of the liquid crystal cells, the liquid crystal composition has a dielectric anisotropy Δε in a range from 5 to 40.

15. The layered type reflective color liquid crystal display element as claimed in claim 1, wherein, in at least one of the liquid crystal cells, the liquid crystal composition has a viscosity in a range from 20 cP to 200 cP.

16. The layered type reflective color liquid crystal display element as claimed in claim 1, wherein a driven voltages required in the liquid crystal cells are substantially the same.

17. The layered type reflective color liquid crystal display element as claimed in claim 1, wherein a phase difference plate is provided between the liquid crystal cells for the red color reflection.

18. The layered type reflective color liquid crystal display element as claimed in claim 17, wherein the liquid crystal compositions used in the liquid crystal cells for the red color reflection are the same.

19. The layered type reflective color liquid crystal display element as claimed in claim 17,
wherein the liquid crystal cells for the red color reflection have gaps in which the respective liquid crystal composition are filled, and
wherein the gaps are substantially the same in thickness.

20. The layered type reflective color liquid crystal display element as claimed in claim 19,
wherein each of the liquid crystal cells has a plurality of scanning electrodes and a plurality signal electrodes; and
wherein the scanning electrodes of one of the liquid crystal cells for the red color reflection are respectively connected to the scanning electrodes of the remaining one of the liquid crystal cells for the red color reflection.

21. The layered type reflective color liquid crystal display element as claimed in claim 1, wherein the liquid crystal compositions used in the liquid crystal cells for the red color reflection are the same.

22. The layered type reflective color liquid crystal element as claimed in claim 1, wherein the liquid crystal cells for the red color reflection have optical rotating directions different each other.

23. A liquid crystal display apparatus comprising:
a layered type reflective color liquid crystal element as claimed in claim 1; and
a drive section for driving each of the liquid crystal cells.

24. A liquid crystal display apparatus as claimed in claim 23, wherein said driver section comprises a driving circuit commonly used for the liquid crystal cells for the red color reflection.

25. A liquid crystal display apparatus as claimed in claim 24, wherein the driving circuit is for scanning the liquid crystal cells for the red color reflection.

26. A liquid crystal display apparatus as claimed in claim 24, wherein said driver circuit is commonly used for all the liquid crystal cells.

27. A liquid crystal display apparatus as claimed in claim 26, wherein the driving circuit is for scanning the liquid crystal cells.

28. A liquid crystal display apparatus as claimed in claim 25, wherein a maximum driving voltage applied from the driver section is not more than 45 V.
